(19) United States
(12) Patent Application Publication
(10) Pub. No.: US 2007/0122623 A1
(43) Pub. Date: May 31, 2007

(54) Localized injection overmolding and articles produced thereby

(76) Inventors: Loic Quehen, Noyelles-les-Vernelles (FR); Christian Robert Bey, Rougegoutte (FR)

Correspondence Address: VISTEON, C/O BRINKS HOFER GILSON & LIONE, PO BOX 10395, CHICAGO, IL, 60610, US

(21) Appl. No.: 11/602,767

(22) Filed: Nov. 21, 2006

(30) Foreign Application Priority Data
Nov. 21, 2005 (FR) FR0511772

(51) Int. Cl. B29C 45/16

(52) U.S. Cl. 428/411.1; 264/255; 264/328.8; 425/542; 425/134

(57) ABSTRACT

A process for the manufacture of a multi-material piece, or element of a piece, notably of thermoplastic material, by localized injection overmolding. The first involves injecting a first plastic material into the volume of a first impression of a completely closed mold. Thereafter, the mold is partially opened to form at least one localized volume of a second impression, which does not extend over the entire surface of the previously injected first part. A second plastic material, different from the first, is locally injected into the localized volume to form at an applied part over the first part.

### BACKGROUND

1. Field of the Invention

The present invention concerns the field of plastics and relates, more particularly, to a process for the manufacturing of pieces that include different types of plastic materials and/or plastic materials of different colors or textures. These pieces (or elements of pieces) are used, for example, in the automotive industry, particularly to create interior panels such as door panels, instrument panels, etc. The present invention also concerns the manufacture of multi-material pieces by injection overmolding and molds particularly suited to such an overmolding process.

2. Related Technology

Many localized injection overmolding processes are already known. Examples include overmolding with the aid of two or more different tools; transfer overmolding; overmolding using a movable block or blocks; or even overmolding using a rotating mold or rotating plate.

Overmolding with the aid of two different tools includes injecting a first thermoplastic material into a first injection mold and then transferring the base piece thus manufactured into a second tool whose impression or cavity differs from that of the first mold, so as to achieve local overmolding with the aid of a second injected material, by means of a second machine. This type of process is particularly costly since it requires the use of as many machines and tools as the number of different sections that are to be formed. Furthermore, the cycle time is quite long for this type of process.

The same process can be adopted using just one tool, but the tool must include more molding cavities. This principle is illustrated in FIG. 1, which shows (in a simplified way) a cross-section of a mold enabling an overmolded piece to be obtained at the bottom of the mold at post B. One of the main problems posed by this sort of process is the size of the tools. This size often makes it unsuitable for molding large pieces or pieces that require an oversized, and therefore very costly, machine to be used. Furthermore, the cycle time is quite long for this type of process.

Rotary overmolding is a process derived from the preceding technique, with the transfer being achieved by means of a rotating base. Such a process is schematically shown in FIG. 2. The drawbacks are the same as with the preceding process. This type of process has also give rise to the idea of bi-material machines with a central rotating plate.

Another known overmolding process is one that uses a mold with one or more movable blocks. This technique, using a single-impression tool, enables both a single-material piece and a bi-material piece to be obtained. However, this technique also has a major drawback in that one or more movable pieces, controlled by hydraulic cylinders, or other means, are required. Operating clearances are therefore required to avoid jamming. Moreover, at high production rates, the clearances will tend to increase. Thus, pieces produced by this type of process inevitably have burrs on the visible surface of the piece, which is clearly unacceptable for aesthetic pieces such as those used for the interior décor of a motor vehicle. Such a process is schematically illustrated in FIG. 3, which shows a simplified cross-section of a mold having an internal impression of variable geometry between injection No. 1 and No. 2, due to the effect of the retraction of the movable block illustrated by the dotted lines.

In short, the known state-of-the-art processes have considerable drawbacks in that specific, numerous, and therefore costly, and on occasion oversized tools, must be used, requiring relatively long cycle times and creating only insufficient and imperfect quality pieces. Thus, as can be seen, the existing techniques do not meet the need that exists for so-called large “aesthetic” pieces such as those currently needed within industry and, in particular, within the automotive industry.

Therefore, a need exists to overcome the above-mentioned drawbacks and provide a cheap and easily-adapted process to enable making multi-material, locally overmolded pieces (or elements of pieces), particularly those consisting of different plastic materials, which can be made at high production rates with a very high level of quality, particularly as regards the finish and aesthetic appearance of the final product.

### SUMMARY OF THE INVENTION

To satisfy the above need, the present invention provides a process for manufacturing a piece, or an element of a piece made of plastic materials and that comprises a first part and at least one additional part (of a different nature and/or color) applied to the first part by localized injection overmolding. The mold used in this process basically comprising two half-molds, one forming the die and the other the punch, and its operation is characterized by comprising: injecting a first plastic material into the volume of a first impression made between the die and the punch when the mold is completely closed; partially opening the mold by separating the die from the punch by at least a predetermined distance d enabling the formation, between the die and the surface of the first layer of plastic material previously injected, of at least one localized volume defining a second impression (which does not extend over the entire surface of the said first layer of plastic material); keeping the two half-molds separated by the above-mentioned predetermined distance d; locally injecting at least a second plastic material of a different nature and/or color than the first into the localized volume so as to form locally at least one applied part directly over the first layer of plastic material, the applied part or parts resulting from this second injection not totally or continuously covering the surface of the first part; repeating, if necessary, the opening and injecting steps so as to obtain stratified layers of applied parts over the first part, with the nature and/or colors of the subsequently injected plastic materials being alternately different; and completely opening the mold to remove the final piece or element of a piece obtained.

Thus, an object of the present invention is to provide a piece, or element of a final piece, made of several different plastic materials, particularly intended for use in the automotive industry and, more particularly, as part of an interior door or instrument panel of a vehicle, obtained by adopting the process according to the invention.

In another aspect, of the present invention is also a mold for adopting the process according to the invention. The mold comprises two half-molds, one forming the die and the other the punch, that create the first impression intended for the first plastic material injected into the mold. One of the half-mold, such as the die, includes at least one means of delimitation projecting from the internal face of the die towards the interior of the mold so as to create, at a predetermined distance between the two half-molds after injection of the first plastic material, a localized volume defining a second impression, on one side of the means of delimitation. This localized volume is formed between the first layer of plastic material previously injected into the space and the surface of the die. Additionally, the second impression covers only part of the surface of the first impression.

### BRIEF DESCRIPTION OF THE DRAWINGS

A better understanding of the invention will emerge from the following description of a preferred embodiment, given by way of a non-limiting example and explained with reference to the accompanying schematic drawings, in which:

FIG. 1 is a simplified cross-section of a mold of a first type of overmolding process according to the state of the art;

FIG. 2 is a simplified cross-section of a mold of a second type of overmolding process according to the state of the art;

FIG. 3 is a simplified cross-section of a mold of a third type of overmolding process according to the state of the art;

FIG. 4a is a simplified partial cross-section of a mold used in a first stage of a process embodying the principles of the present invention;

FIG. 4b is a simplified partial cross-section of the mold of FIG. 4a in a second stage of the process;

FIG. 4c is a simplified partial cross-section of the mold of FIG. 4b in a third stage of the process; and

FIG. 5 is an illustration of an example of a bi-material piece obtained according to the principles of the present invention.

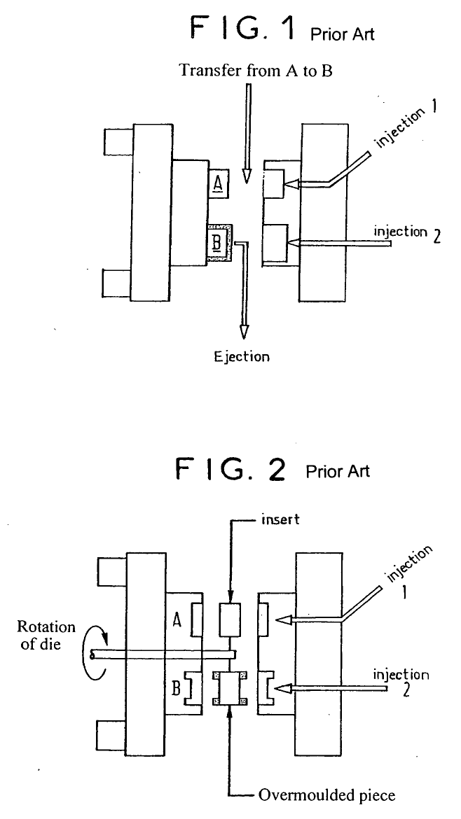

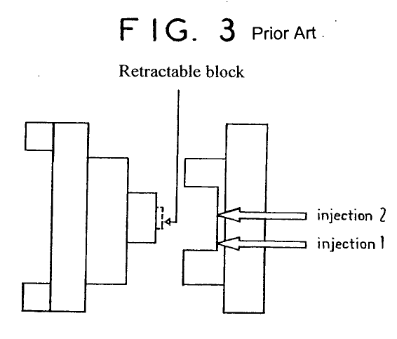

### DETAILED DESCRIPTION

As briefly mentioned above, the present invention concerns a multi-material, preferably bi-material, injection process and, more particularly, a localized overmolding process of a first plastic material by a second. It is also important to note that the localized overmolding concept is, within the scope of the present invention, based on a total opening (over the entire surface of the first molded piece) of the injection mold. This is done between the injection of the first thermoplastic material and the injection of the second thermoplastic material or subsequent thermoplastic materials. The process enables locally overmolded pieces to be made without an obvious mold joining line between the single- and bi-material areas.

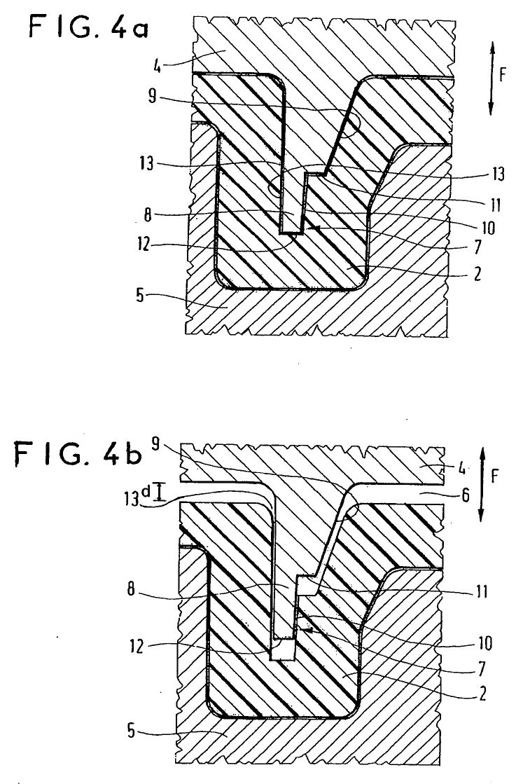

A localized overmolding process embodying the principles of the present invention thus involves the bi-material injection with a single-impression tool. For clarity's sake, FIGS. 4a to 4c show only a portion of a cross-section of a mold chosen to explain, in a non-limiting way, the manufacturing of a bi-material article or piece according the principles of the invention. The other elements and devices that comprise the mold which are usually present, such as general mechanical devices to operate, close, seal, supply and injection materials into the mold, etc., are all of a well-known construction and need not be described in greater detail. The same applies to the practical details regarding the implementation of this process (injection temperatures and pressures, setting time, nature and properties, such as compatibility of the materials, that make up the molds and the injected pieces, etc.). Such details are those conventionally used. A person skilled in the art will be familiar and will know how to chose or determine these criteria for himself, without difficulty, with the exception of particular points specific to the present invention and which are described in greater detail below.

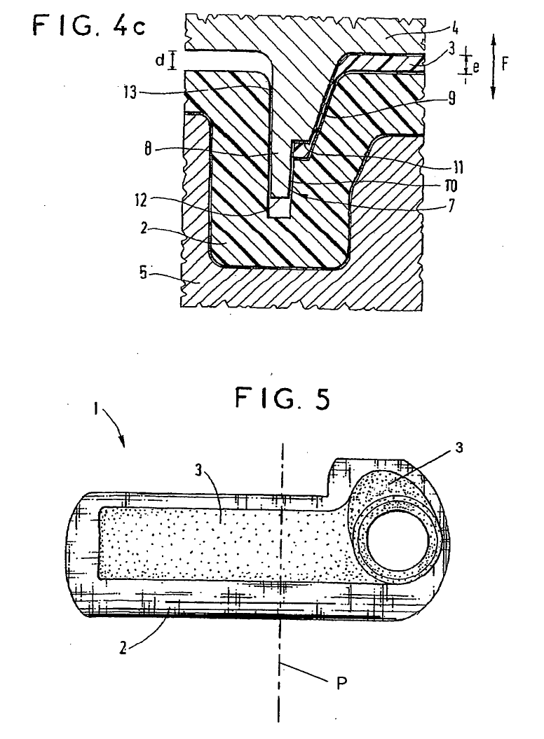

According to one embodiment of the present invention, and as shown in the accompanying FIGS. 4a, 4b, 4c and 5, a process is provided for forming a piece 1 (or part of a piece) having a first part 2 and at least one applied part 3, the applied part 3 being provided on the first part 2 by localized injection overmolding. Localized overmolding is achieved via the injection of the plastic material forming the applied part 3 (which may be of a different nature and/or color than that of the first part 2) into a mold having to half molds 4 and 5, one forming the die 4 and the other forming the punch 5 of the mold.

Generally, the process includes the injecting of a first plastic material into the cavity of a first impression made between the mold halves 4 and 5 when the mold is completely closed. Thereafter, the mold is partially opened separating the die 4 from the punch 5 by at least a predetermined distance d. This enables the formation between the surface die 4 and the surface of the previously injected plastic material, at least one localized volume 6 defining a second impression. Notably the second impression does not extend over the entire surface of the first layer of plastic material. Keeping the two mold halves 4 and 5 separated by the above-mentioned predetermined distance d, a second plastic material, of a different nature and/or color than the first, is injected into the localized volume 6 of the second impression. This causes at least one applied part 3 to be locally formed directly over the first plastic material that forms the first part 2 of the piece 1 being made. The applied part 3 thus results from the second injection and does not totally or continuously cover the surface of the first part 2. If necessary, the opening and injecting steps can be repeated so as to obtain additional and stratified layers of applied parts over the first part 2. Obviously the nature and/or color of the subsequently injected plastic materials may be alternately different. Finally, the mold is completely opened to remove the obtained final piece 1.

Because of the present process, it is possible to use a tool of a relatively contained size, and therefore a machine of normal size, while maintaining a reasonable cycle times.

This is particularly possible because the tool is opened over the entire surface of the mold while achieving only local overmolding of the piece. Until now, this was unthinkable for a person skilled in the art (plastics specialist). As shown in FIGS. 4b and 4c, the portion of the piece 2 that is not to be covered by a second material is no longer in contact with the wall of the mold half 4 at the time of injection of the second molten thermoplastic material. It should be noted that in this technique, one of the mold halves 4 includes a portion that is always in contact with a portion of the piece already injected 2 and that will not be covered during the injection of the subsequent material.

In order to keep the two mold halves 4, 5 separated during the subsequent injection stage, packing pieces, which can withstand the closing force applied to the half-molds 4, 5, are interposed in the mold joint plane before the second injection or each subsequent injection. These packing pieces are known in the industry and need not be described in further detail. Similarly, all the mechanical means of closing, monitoring and control that are usually adopted in the field injection molding, can be used with the packing pieces.

The various plastic materials are injected into the localized volume 6 via separate channels arranged in the die 4 of the mold. The means to be provided for this purpose are those commonly used in the technique of injection or injection overmolding and therefore require no further explanation.

Preferably, the outlet of the channel for the injection of the second plastic material (and the outlets of the channels for the injection of the other plastic materials or additional plastic materials) is located in the die 4 at the localized volume 6 (or volumes) created by the second impression (or by the other impressions). In this way, the different molten material is injected directly at the required places and at the correct temperature.

With regard to the first injection and subsequent injections (2^{nd}, 3^{rd} . . . n^{th} materials) and/or following injections (several injections of different material in different places on the same piece), care must be taken to ensure that the materials used are chemically (from the molecular, solubility, etc. point of view) and physically (from the rheological, melting temperature, etc. point of view) compatible with each other so as to avoid any harmful deterioration (degradation, spreading, mixing, etc.) of the layers already formed caused by the subsequent material or materials.

In order to prevent the layers that have already been injected from being re-melted by the subsequently injected materials, a longer or shorter waiting time can be notably envisioned before the next subsequent injection or injections. This waiting time will depend on the difference between the melting or softening points of the materials that come into contact with each other, and is capable of being determined and optimized, for example, by measuring the temperature of the mold halves 4, 5 or the already injected layers, using the appropriate known sensors or probes. This waiting time is generally only on the order of a few seconds.

According to one particularly advantageous characteristic, the process according to the invention is characterized in that two plastic materials of different natures or different colors are injected to obtain a bi-material piece 1 or element of a piece.

By way of a non-limiting example, FIG. 5 illustrates a portion of an element of an instrument panel for a motor vehicle. This piece 1 includes a first part 2 (base piece) onto which has been overmolded a second applied part 3 (overmolded piece) that includes, on the right side of the illustration, an element with a circular opening designed to receive a ventilation register.

Preferably, the first plastic material forming the first part 2 is a rigid thermoplastic material ensuring the essential nature of the mechanical properties of the final piece. The second or subsequent plastic materials, injected on their own or in layers to form the applied part or parts 3, may be flexible thermoplastic materials giving the final piece 1 a texture and/or a special appearance or color.

As noted above, the opening and subsequent localized injection stages of the process can be repeated to obtain stratified layers or multi-layers of applied parts 3 on the first part 2 and the natures and/or colors of the subsequently injected plastic may be alternately different. For example, one could provide an intermediate reinforcing layer made of an injectable material having particular properties when it is solidified and further finish the piece with an injected material having a particularly pleasant feel or resistance to scratches.

The injectable materials capable to being used in the process according to the invention, in addition to the synthetic and preferably thermoplastic materials usually adopted for this type of application such as polypropylene (PP) or other polyolefines (PO) and thermoplastic elastomers (TPE), are the following materials: acrylonitrile butadiene styrene (ABS), acrylonitrile butadiene styrene/polycarbonate (ABS/PC), polycarbonate (PC), thermoplastic urethane elastomers (TPU), as well as any other compatible injectable material known to persons skilled in the art. Material colors can also be varied in the choice of the different injected materials, including inserting translucent or transparent layers to create a particular aesthetic effect for example.

For a bi-material piece 1, the first plastic material of the first part 2 is preferably chosen from the group made up of rigid thermoplastic materials like rigid polyolefines (PO) such as polypropylene (PP), acrylonitrile butadiene styrene (ABS), polycarbonate (PC), polyvinylchloride (PVC), acrylonitrile butadiene styrene/polycarbonate (ABS/PC) or any other rigid thermoplastic material. The second material for the applied part 3 is selected from the group made up of flexible or semi-rigid thermoplastic materials such as thermoplastic elastomers (TPE), polypropylene/styrene ethylene butylenes styrene (PP/SEBS), polypropylene/ethylene propylene diene monomer (PP/EPDM), thermoplastic-urethane elastomers (TPU), flexible polyvinylchloride (PVC) or any other flexible or semi-rigid material.

A further aim of the invention is to provide a mold for adopting the process described above. As illustrated in FIGS. 4a, 4b and 4c, which represents a partial cross-section of a mold by way of a non-limiting example, the mold comprises two half-molds 4, 5, one forming the die and the other the punch to make the first impression or cavity intended for the first plastic material injected into the said mold.

The mold is characterized in that at least one of the half-molds 4, 5 includes a means of delimitation 7 projecting from the cavity or internal surface of that half-mold toward the other half-mold. In FIGS. 4a, 4b, and 4c, this means of delimitation 7 is provided on the die 4. After injecting the first plastic material into the cavity of the fully closed mold and upon subsequent separation of the die 4 and punch 5, to one side of the means of delimitation 7 the localized volume 6 for the second impression (forming the applied part 3) is defined (between the surface of the die 4 and the surface of the previously injected first plastic material of the first impression (forming the first part 2)). Accordingly, the second impression will cover only a part of the surface of the first impression.

The means of delimitation 7 is made in the form of a peripheral finger 8 projecting from the die 4 towards the interior of the mold. The peripheral finger 8 forms an enclosed circumferential shape on the die 4, and thus defines a barrier that the second material cannot overcome when it is injected to create the applied part 3.

From this it is seen that if the separation of the die 4 and punch 5 is repeated after the second injection, for the purposes of a third or n^{th} injection, the peripheral finger 8 will again allow the localized volume to be created, between the layer last injected and the face of the die 4, so as to receive the molten material of this new injection stage.

The views shown in FIGS. 4a to 4c are obtained by cutting along a plane P (see FIG. 5), which contains the direction F in which the die 4 and punch 5 are separated and/or brought together. This plane P is generally perpendicular to the general plane of the die 4 and punch 5.

According to another characteristic of the mold, the cross-section of the peripheral finger 8, in a direction perpendicular to the plane P, decreases in width from its base on the die 4 toward its tip in the interior of the mold.

As shown in FIGS. 4a to 4c, the peripheral finger 8 is provided (on the side that will define the localized volume 6) with at least one portion of a wall that is oblique in relation to direction F (the latter being symbolized by a double arrow). The oblique wall 9 extends from the internal face of the die 4 in the direction of the internal face of punch 5 and participates during the separation of the die 4 and punch 5 and in the formation of the localized volume 6. Preferable, the oblique wall 9 forms an angle of between 1° and 45° in relation to the direction of separation F of the die 4 and punch 5. A portion 10 of the wall of the peripheral finger 8 extends in a direction which is parallel, or essentially parallel, to the said direction F. This parallel wall 10 only partially participates in the formation of the localized volume 6.

If there are to be a plurality of portions of oblique walls 9 on the peripheral finger 8, they may or may not be adjacent and the angles formed in relation to direction F, as well as their sum, shall be within the above-mentioned range.

According to one particular embodiment, at least one step 11, perpendicular to the direction of separation F, is envisioned in the peripheral finger 8. Such a step 11 may be located between the oblique wall 9 and the parallel wall 10. The step 11 also participates in defining the localized volume (see FIG. 4c). Such a step 11 creates, in cooperation with the parallel wall 10, a lateral stop that delimits the subsequently injected material of the applied part 3.

According to another aspect of the invention, the mold is also characterized in that the peripheral finger 8 ends, at the extremity or tip that faces the punch 5, in an end wall 12 oriented perpendicular to the direction of separation F. The end wall 12 continues along on external face of the peripheral finger 8 in the form of a return wall 13, generally parallel to the direction of separation F and extending up to the base formed by the die 4.

According to another variation not shown, the mold according to the present invention is characterized in that the wall 12 extends along the external face of the peripheral finger 8 in the form of a return wall 13 forming an angle of less than 5° in relation to the direction of separation F.

The layer thickness of the second (or n^{th}) injected material, also sometimes called the “skin material”, is variable and depends chiefly on the angle (the “rake”) of the oblique wall 9, in relation to the direction of separation F (cf. FIG. 4c).

It has been found particularly advantageous to provide the means of delimitation 7 in the form of the peripheral finger 8 described above. This finger 8 forms a sort of sealing edge machined directly into the die 4 of the injection tool. As previously described, the shape of the peripheral finger 8 notably comprises two special areas.

In the first area, the angle of the oblique wall 9 is created. This angle notably allows a slight thickness of the so-called “skin” material to be obtained for the applied part 3. As this thickness is relatively thin, the front of the injected plastic material for the applied part 3 will cool very quickly. On injection, cooling time varies depending on the square of the thickness of material. In this area the injected material begins to be cool. Then, the front of the material arrives in the second area of the peripheral finger or sealing edge. In this area, a step of around 0° is formed (parallel or essentially parallel portion 10). Thus, on continue initial opening of the tool, no free space will be made and the front of material will be completely stopped. It is also important to note that the first area, with a slight rake, is necessary. In fact, if the latter did not exist, the material would not cool and the second material would probably melt the first material, thus causing leakage. The process would therefore not lead to the expected result, unless the overmolded area or applied part 3 was very small.

Similarly, the return wall 13 forms an angle of less than 5° in relation to the direction of separation F. This allows the injected material in this area to finally set in the highly unlikely event of the preceding barrier created by the portion or portions of parallel or essentially parallel walls 10 (zero or almost zero rake) is found to be insufficient.

It will be noted that the sealing edge formed by the peripheral finger 8 will form a groove on the molded piece 1. This groove may be advantageously used as a transition area to mask the finish in cases where the applied piece 3 is to be covered locally by another material (textile, leather, decorative or protective film, etc.) in another subsequent manufacturing stage (sheathing, display, etc. or a trim material is to be located in the groove.)

By way of a practical non-limiting example, a cover for an inflatable restraint of the instrument panel is produced by adopting the process according to the invention. In a first instance, when the tool, that is to say the mold, is closed and secured with a force in the order of 6,500 kN, a so-called “aesthetic” polypropylene is injected at a temperature in the order of 240° C. into the cavity formed by the mold, the cavity being about 3 mm thick. After the first injected material forming the base piece has compacted and cooled for about 15 seconds, the tool is opened by at least 3 mm to enable the packing pieces to be installed in the joint plane. The mold is then closed again fully home against the packing pieces and is re-secured with a force of about 6,000 kN. A space of e=1 mm on average is created in the tool into which a thermoplastic elastomer, such as PP/SEBS as the material of the applied piece, is injected at a temperature of around 220° C. in this particular case. After a cooling period in the order of 10 seconds, the mold is opened and the biomaterial piece 1 formed is ejected.

Other non-limiting applications of the process according to the invention include manufacturing pieces for the interior of motor vehicles such as an instrument panel body with an overmolded and integrated cover, a door panel with an insert and/or an overmolded band injected into the same tool, an instrument panel console with an overmolded tactile piece (i.e. pleasant to the touch) and decorative area, which can include different elements or devices, such as control buttons. Other decorative or tactile areas can of course be made over all of these pieces or any other piece of motor vehicle interior trim.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A process for manufacturing a part, or an element of a part, made of plastic material and having a first part and at least one applied part, the applied part being of a plastic material that is of a different nature and/or color to that of the first part, the process comprising the steps of:
injecting a first plastic material into a first volume defining a first impression made between a die and a punch of a mold, the first plastic material being injected until the first volume is completely closed;
partially opening the mold by separating the die from the punch by a predetermined distance thereby forming at least one localized volume between the die and a surface of the first plastic material, the localized volume defining a second impression that does not extend over the entire surface of the first plastic material;
keeping the die and the punch separated by the predetermined distance;
injecting a second plastic material into the localized volume to form an applied part directly over the first layer of plastic material, the applied part covering only a portion of the surface of the first plastic material, the second plastic material being different from the first plastic material;
completely opening the mold and removing the molded part therefrom.

2. The process according to claims 1 further comprising the steps of:
partially opening the mold by separating the die from the punch by a second predetermined distance thereby forming at least one second localized volume between the die and a surface of the second plastic material, the second localized volume defining a third impression that does not extend over the entire surface of the first plastic material;
keeping the die and the punch separated by the second predetermined distance;
injecting a third plastic material into the second localized volume to form a second applied part over at least a portion of the first applied part, the third plastic material being different from the second plastic material.

3. The process according to claim 1, wherein the step of keeping the die and punch separated includes the step of inserting packing pieces between the die and punch before the injecting of the second plastic material, the packing piece adapted to withstand a closing force applied to the die and punch.

4. The process according to claim 1, wherein the injecting of the first and second plastic materials are done via separate channels arranged in the die of the mold.

5. The process according to claim 1, wherein the step of injecting the second plastic material injects the second plastic material directly into the localized volume via an outlet located in the die of the mold at the localized volume.

6. The process according to claim 1, wherein the first plastic material is injected to form a rigid thermoplastic first part that provides the general nature of the mechanical properties of the final piece, and the second plastic material is injected to form a flexible thermoplastic applied part giving the final piece a desired appearance.

7. The process according to claim 6 wherein the first plastic material is selected from the group made up of rigid thermoplastic polyolefine material including polypropylene (PP), acrylonitrile butadiene styrene (ABS), polycarbonate (PC), polyvinylchloride (PVC) and acrylonitrile butadiene-styrene/polycarbonate (ABS/PC) and in t

8. The process according to claim 6 wherein the second plastic material for the applied part is selected from the group made up of flexible or simi-rigid thermoplastic materials including thermoplastic elastomers (TPE), polypropylene/styrene ethylene butylenes styrene (PP/SEBS), polypropylene/ethylene propylene diene monomer (PP/EPDM), thermoplastic-urethane elastomers (TPU) and flexible polyvinylchloride (PVC).

9. An automotive component manufactured by the process of claim 1.

10. The automotive component of claim 9 wherein the component is one of at least a portion of an interior door panel, and an instrument panel.

11. A molding apparatus for manufacturing part having a first piece and an applied piede located on the first piece, the apparatus comprising:
two half-molds, one forming a die and the other forming a punch, the half-molds defining a first impression intended to receive a first plastic material injected into the mold;
at least the die of the mold including at least one delimitation portion projecting from an internal face of the die towards an interior of the mold, upon separating of the two half-molds by a predetermined distance after the injecting of the first plastic material into the mold, the delimitation portion cooperating to define a localized volume bounded on one side by a surface of the die and being bounded on an opposing side by a surface of the first plastic material, the localized volume covering only a portion of the surface of the first impression.

12. A molding apparatus according to claim 11, wherein the delimitation portion is in the form of a peripheral finger projecting from the die towards the interior of the mold, the peripheral finger forming a enclosed area on the die.

13. A molding apparatus according to claim 12, wherein the peripheral finger generally decreases in width as it progresses away from its base on the die and towards the interior of the mold.

14. A molding apparatus according to claim 12, wherein the peripheral finger has on an internal face toward the localized volume at least one wall portion that is oblique in relation to a direction in which the half-molds are separated, the oblique wall portion extending from the internal face of the die, the oblique wall portion participating, during the said separation of the half-molds, in the formation of the localized volume, the peripheral finger including a parallel portion being parallel to the direction of separation, at leas a portion of the parallel portion not cooperating in defining the localized volume.

15. A molding apparatus according to claim 14, wherein the oblique wall portion forms an angle of between 1° and 45° in relation to the direction of separation of the half-molds.

16. A molding apparatus according to claim 14, wherein at least one step perpendicular to the direction of separation is formed in the internal face of the peripheral finger between the oblique wall portion and the parallel portion, the step cooperating in the formation of the localized volume.

17. A molding apparatus according to claim 14, wherein the peripheral finger terminates in an end wall perpendicular to the direction of separation, the end wall continuing along an external face of the peripheral finger in the form of a return wall that is generally parallel to the direction of separation and extending up to the die of half-mold.

18. A mold according to claim 17, wherein the return wall forms an angle of less than 5° in relation to the direction of separation.
